(19) United States
(12) Patent Application Publication
(10) Pub. No.: US 2026/0093138 A1
(43) Pub. Date: Apr. 2, 2026

(54) DISPLAY APPARATUS

(71) Applicant: SAMSUNG ELECTRONICS CO., LTD., Suwon-si (KR)

(72) Inventors: Jungwon KANG, Suwon-si (KR); Jin JUNG, Suwon-si (KR)

(73) Assignee: SAMSUNG ELECTRONICS CO., LTD., Suwon-si (KR)

(21) Appl. No.: 19/321,944

(22) Filed: Sep. 8, 2025

Related U.S. Application Data
(63) Continuation of application No. PCT/KR2025/013085, filed on Aug. 27, 2025.

(30) Foreign Application Priority Data
Sep. 28, 2024 (KR) 10-2024-0132270

(51) Int. Cl. G02F 1/1333; G02F 1/13357

(52) U.S. Cl. CPC G02F 1/133314; G02F 1/133325; G02F 1/133615

(57) ABSTRACT

A display apparatus may include: a display panel; a rear chassis on a rear side of the display panel, the rear chassis including a plurality of coupling holes; at least one bracket on a front side of the rear chassis, the at least one bracket coupled to the plurality of coupling holes; at least one first circuit board on a rear side of the rear chassis, the at least one first circuit board being on at least a portion of the at least one bracket; a light source on a front surface of the rear chassis; and a second circuit board connected to the light source; wherein the at least one bracket includes: a plurality of coupling ribs coupled to first coupling holes from among the plurality of coupling holes; and a plurality of hooks coupled to second coupling holes from among the plurality of coupling holes.

### CROSS-REFERENCE TO RELATED APPLICATIONS

This application is a bypass continuation of International Application No. PCT/KR2025/013085, filed in the Korean Intellectual Property Office on August 27, 2025, which claims priority to Korean Patent Application No. 10-2024-0132270, filed in the Korean Intellectual Property Office on September 28, 2024, the disclosures of which are incorporated herein by reference in their entireties.

### BACKGROUND

### 1. Field

The disclosure relates to a display apparatus, in which a rear chassis is injection molded, and a coupling structure of a bracket coupled to the rear chassis for seating a circuit board is improved.

### 2. Description of Background Art

A display apparatus is a device that displays a screen, and includes monitors and televisions. The display apparatus is a type of output device that converts acquired or stored electrical information into visual information and displays such information to a user, and is used in various fields such as homes and businesses.

A display apparatus may include a monitor device connected to a personal computer (PC) or server computer, a handheld computer device, a navigation terminal device, a television device, an internet protocol television (IPTV) device, a portable terminal device (e.g., a smartphone, tablet PC, personal digital assistants (PDA), or cellular phone), various display devices used to play images such as advertisements or movies in industrial sites, or various other types of audio/video systems.

A display device may include a display panel, a backlight unit that emits light to the display panel, and a rear chassis to which the display panel and the backlight unit are fixed. The rear chassis may include a plurality of boards that control the operation of the display panel and the backlight unit, or provide power to the display panel and the backlight unit.

### SUMMARY

According to an aspect of the disclosure, a display apparatus in which a rear chassis is injection molded may be provided.

According to an aspect of the disclosure, a display apparatus with an improved coupling structure of a bracket coupled to an injection-molded rear chassis for seating a circuit board may be provided.

According to an aspect of the disclosure, a display apparatus in which an injection-molded rear chassis is positioned between a circuit board and a bracket on which the circuit board is seated may be provided.

According to an aspect of the disclosure, a display apparatus may include: a display panel; a rear chassis on a rear side of the display panel, the rear chassis including a plurality of coupling holes; at least one bracket on a front side of the rear chassis, the at least one bracket coupled to the plurality of coupling holes; at least one first circuit board on a rear side of the rear chassis, the at least one first circuit board being on at least a portion of the at least one bracket, the portion protruding through the rear chassis; a light source on a front surface of the rear chassis; and a second circuit board connected to the light source; wherein the at least one bracket includes: a plurality of coupling ribs coupled to first coupling holes from among the plurality of coupling holes; and a plurality of hooks coupled to second coupling holes from among the plurality of coupling holes.

According to an aspect of the disclosure, a display apparatus may include: a display panel; a rear chassis on a rear side of the display panel, the rear chassis including at least one coupling hole and at least one through-hole; a bracket on a front side of the rear chassis, the bracket coupled to the at least one through-hole, and the bracket including at least one bead protruding, in the at least one through-hole, towards a rear side of the rear chassis, and at least one first circuit board on the at least one bead, on a rear side of the rear chassis, wherein the rear chassis is between the bracket and the at least one first circuit board.

According to an aspect of the disclosure, a display apparatus may include: a display panel; a rear chassis on a rear side of the display panel, the rear chassis including a plurality of coupling holes; at least one bracket on a front side of the rear chassis, the at least one bracket coupled to the plurality of coupling holes; at least one first circuit board on a rear side of the rear chassis, the at least one first circuit board being on at least a portion of the at least one bracket, the portion protruding through the rear chassis; wherein the at least one bracket includes: a plurality of coupling ribs coupled to first coupling holes from among the plurality of coupling holes; and a plurality of hooks coupled to second coupling holes from among the plurality of coupling holes.

Aspects of embodiments of the disclosure are not limited to the aspects mentioned above, and other aspects of embodiments of the disclosure not mentioned will be clearly understood by those skilled in the art from the description below.

### BRIEF DESCRIPTION OF DRAWINGS

FIG. 1 is an exploded perspective view of a display apparatus according to an embodiment.

FIG. 2 is a view illustrating a state in which a bracket, on which a first circuit board and a second circuit board are seated, is coupled to a front surface of a rear chassis according to an embodiment.

FIG. 3 is a view illustrating the display apparatus of FIG. 2 from another direction.

FIG. 4 is a view illustrating a state in which a plurality of second coupling ribs of a second bracket is coupled to a plurality of second coupling holes of a rear chassis according to an embodiment.

FIG. 5 is an enlarged view illustrating a state in which a second coupling rib is coupled to a second coupling hole according to an embodiment.

FIG. 6 is a view illustrating a state in which a plurality of second hooks of a second bracket are hook-coupled to a plurality of fourth coupling holes of the rear chassis according to an embodiment.

FIG. 7 is a cross-sectional view illustrating a state in which a second hook is hook-coupled to a fourth coupling hole according to an embodiment.

FIG. 8 is a view illustrating a state in which a plurality of first coupling ribs of a first bracket is coupled to a plurality of first coupling holes of the rear chassis according to an embodiment.

FIG. 9 is a cross-sectional view illustrating a state in which a first hook is hook-coupled to a third coupling hole according to an embodiment.

FIG. 10 is a view illustrating a state in which a first bracket and a second bracket are coupled to a front surface of the rear chassis according to an embodiment.

FIG. 11 is a view illustrating a state in which a power board and a control board are seated on a bracket from a rear surface of a rear chassis according to an embodiment.

FIG. 12 is a view illustrating a state in which a power board is being seated on a first bracket according to an embodiment.

FIG. 13 is a cross-sectional view illustrating a state in which a power board is seated on a first bracket according to an embodiment.

FIG. 14 is a view illustrating a state in which a control board is seated on a first bracket and a second bracket according to an embodiment.

FIG. 15 is a cross-sectional view illustrating a state in which a control board is seated on a first bracket and a second bracket according to an embodiment.

FIG. 16 is a view illustrating a state in which a power board and a control board are seated on a first bracket and a second bracket from a rear surface of a rear chassis according to the embodiment.

### DETAILED DESCRIPTION

Various example embodiments of the disclosure are not intended to limit the disclosure to specific embodiments, and the disclosure should be understood to include various modifications, equivalents, and substitutes of the example embodiments.

In connection with the description of the drawings, similar reference numerals may be used for similar or related components.

Also, the terms used herein are used to describe example embodiments and are not intended to limit and/or restrict the disclosure. The singular forms “a,” “an” and “the” are intended to include the plural forms as well, unless the context clearly indicates otherwise. In this disclosure, the terms “including,” “comprising,” “having,” and the like are used to specify features, figures, steps, operations, elements, components, or combinations thereof, but do not preclude the presence or addition of one or more of the features, figures, steps, operations, elements, components, or combinations thereof.

In the disclosure, phrases, such as “A or B,” “at least one of A and B,” “at least one of A or B,” “A, B or C,” “at least one of A, B and C,” and “at least one of A, B, or C” may include any one or all possible combinations of the items listed together in the corresponding phrase among the phrases.

The term of “and/or” includes a plurality of combinations of relevant items or any one item among a plurality of relevant items.

It will be understood that, although the terms “first,” “second,” “primary,” “secondary,” etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In addition, in the disclosure, the meaning of “identical” includes cases where properties are similar to each other or similar within a certain range. Furthermore, identical means “substantially identical”. The meaning of substantially identical should be understood to include numerical values within manufacturing error ranges or differences within a range that is insignificant with respect to a reference numerical value as falling within the scope of ‘identical’.

In addition, terms such as “part,” “portion,” “unit,” “block,” “member,” “module,” and the like, may refer to a unit that processes at least one function or operation. For example, these terms may refer to at least one hardware such as a field-programmable gate array (FPGA) or application specific integrated circuit (ASIC), at least one software stored in memory, or at least one process processed by a processor.

Meanwhile, terms used in the following description such as “front,” “rear,” “left,” and “right,” and the like, are defined based on the drawings, and the shape and position of each element are not limited by these terms.

Hereinafter, various non-limiting example embodiments of the disclosure will be described in detail with reference to the accompanying drawings.

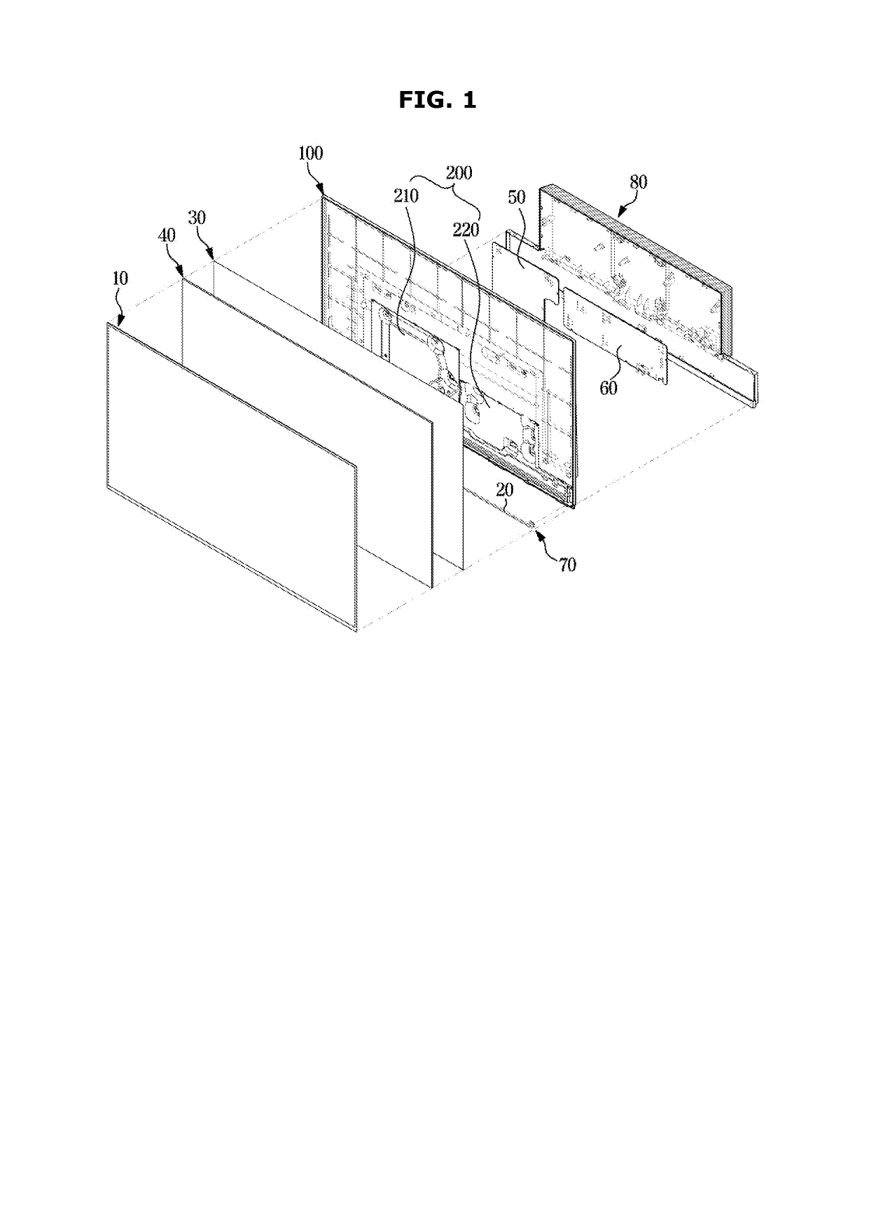

FIG. 1 is an exploded perspective view of a display apparatus according to an embodiment.

As shown in FIG. 1, a display apparatus may include a display panel 10 on which an image is displayed. The display apparatus may include a plurality of light sources 20 disposed on a rear side of the display panel 10 to emit light to the display panel 10. The display apparatus may include a light guide plate 30 disposed on the rear of the display panel 10 to guide light emitted from the plurality of light sources 20 to the display panel 10. The display apparatus may include an optical sheet 40 disposed between the display panel 10 and the light guide plate 30 to improve optical properties of light guided to the display panel 10 by the light guide plate 30. The display apparatus may include a rear chassis 100 disposed on the rear side of the display panel 10 and forming a part of a rear exterior of the display apparatus. The display apparatus may include a rear cover 80 coupled to a rear surface of the rear chassis 100 and forming the rear exterior of the display apparatus together with the rear chassis 100.

According to some embodiments, a reflective sheet that reflects light emitted through the rear surface of the light guide plate 30 forward may be disposed on the rear side of the light guide plate 30.

The display panel 10 may be formed as a liquid crystal display panel using liquid crystals, and may include a thin film transistor (TFT) substrate on which a TFT is formed, a color filter (CF) substrate (not shown) facing the TFT substrate, and a liquid crystal disposed between the TFT substrate and the CF substrate.

The TFT substrate may be a transparent glass substrate on which TFTs, which are switching elements, are formed in a matrix.

Data lines may be connected to source terminals of the TFTs, gate lines may be connected to gate terminals, and pixel electrodes made of a transparent conductive material may be connected to drain terminals.

The CF substrate may be disposed opposite the TFT substrate with a certain gap, and may be a substrate on which red, green, blue (RGB) pixels, which are color pixels that are expressed as a predetermined color when light passes therethrough, may be formed by a thin film process. A common electrode made of a transparent conductive material may be formed on a front surface of the CF substrate.

In the display panel 10 having the configuration described above, when power is applied to the gate terminal of the TFT, an electric field may be formed between the pixel electrode and the common electrode, and an arrangement of liquid crystals interposed between the TFT substrate and the CF substrate may be changed by the electric field.

The display panel 10 may form an image by adjusting the arrangement of liquid crystals. However, since the display panel 10 may not emit light by itself, it may display an image by receiving light from the plurality of light sources 20 located at the rear of the display panel 10.

A drive printed circuit board that supplies drive signals to the display panel 10 may be disposed on a lower portion of the display panel 10, and the display panel 10 and the drive printed circuit board may be electrically connected by a plurality of flexible circuit films on which a drive chip is mounted on one side.

The plurality of light sources 20 may be provided as a plurality of light emitting diodes (LEDs). The plurality of light sources 20 may be fixed to a second circuit board 70, which will be described below. The second circuit board 70 on which the plurality of light sources 20 are fixed may be seated on a bracket 200, which will be described below. The bracket 200 may be coupled to a front surface of the rear chassis 100. The plurality of light sources 20 may be disposed to be spaced apart from a lower end portion of the light guide plate 30 by a certain gap to emit light to the lower end portion of the light guide plate 30, and the light emitted to the light guide plate 30 may be redirected by the light guide plate 30 and transmitted to the display panel 10.

The light guide plate 30 may be disposed on the rear side of the display panel 10 and may guide light emitted from the plurality of light sources 20 to the display panel 10. The light guide plate 30 may be seated on the rear chassis 100. While the drawings illustrate an edge-type display method, embodiments of the disclosure are not limited thereto. It should be appreciated that embodiments of the disclosure may also apply a direct-type display method.

The optical sheet 40 may be disposed between the display panel 10 and the light guide plate 30 to improve optical properties of light guided to the display panel 10 by the light guide plate 30, and may include a diffusion sheet to diffuse light guided through the light guide plate 30 to improve luminance uniformity, a prism sheet to align a direction of light so that the light diffused by the diffusion sheet may be incident perpendicularly on the display panel 10, and a protective sheet to protect the prism sheet.

The rear chassis 100 may be disposed on the rear side of the display panel 10 to form part of the rear exterior of the display apparatus. The rear chassis 100 may be injection molded. Because the rear chassis 100 may be injection molded, the display apparatus may be lightweight overall. The bracket 200 may be coupled to the front surface of the rear chassis 100. The bracket 200 may be provided in plural. The rear chassis 100 will be described in more detail below.

The rear cover 80 may be coupled to the rear surface of the rear chassis 100 to form the rear exterior of the display apparatus together with the rear chassis 100. The rear exterior of the display apparatus may be formed by the rear chassis 100 and the rear cover 80.

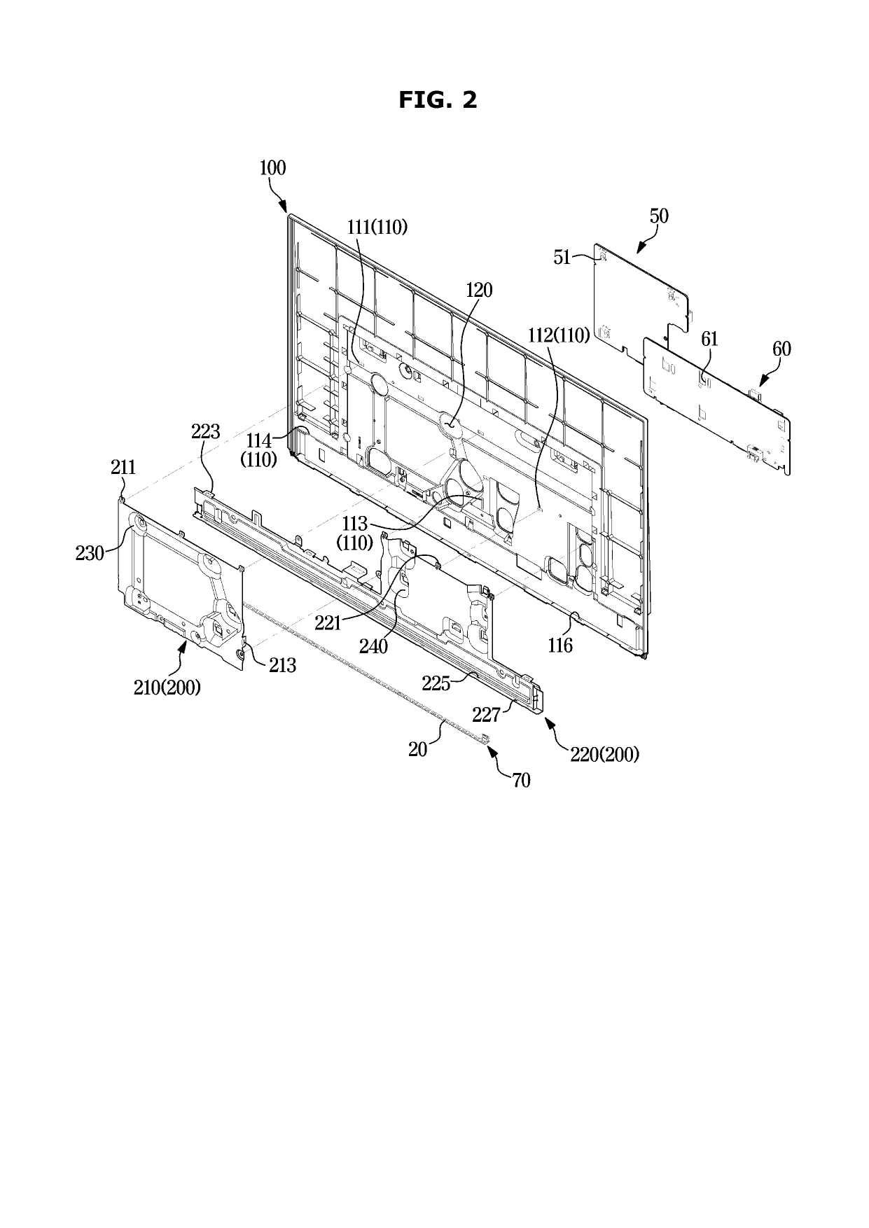

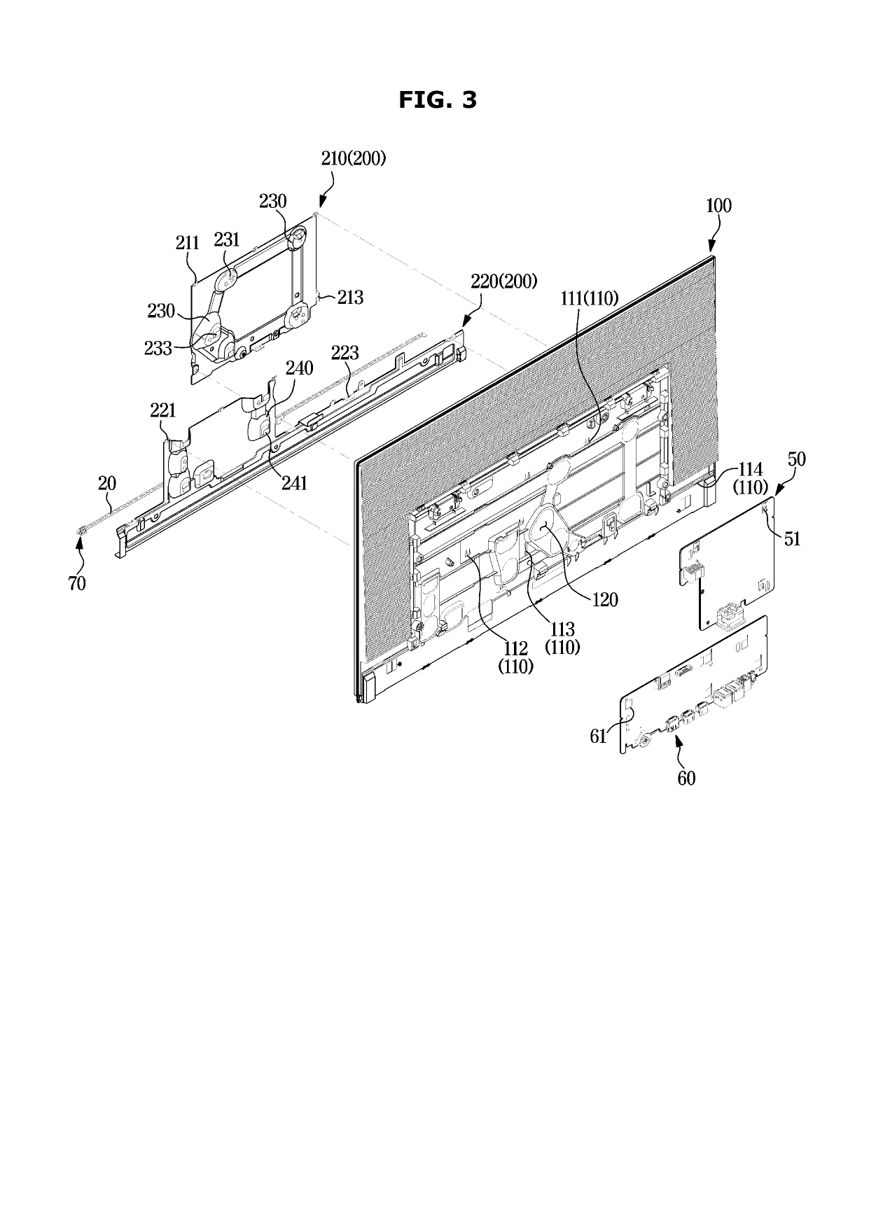

FIG. 2 is a view illustrating a state in which a bracket, on which a first circuit board and a second circuit board are seated, is coupled to a front surface of a rear chassis according to an embodiment. FIG. 3 is a view illustrating the display apparatus of FIG. 2 from another direction.

As shown in FIGS. 2 and 3, the bracket 200 may be coupled to the front surface of the rear chassis 100 that is injection molded. The rear chassis 100 may include a plurality of coupling holes 110 to which the bracket 200 is coupled. The rear chassis 100 may include a plurality of through-holes 120 that allow a portion of the bracket 200 coupled to the front surface of the rear chassis 100 to protrude to the rear surface of the rear chassis 100. A more detailed description of the plurality of coupling holes 110 and the plurality of through-holes 120 of the rear chassis 100 will be described below.

The bracket 200 may be coupled to the front surface of the rear chassis 100. The bracket 200 may be coupled to the plurality of coupling holes 110 on the front surface of the rear chassis 100. The bracket 200 may include a plurality of coupling ribs (e.g., first coupling ribs 211 and second coupling ribs 221) that is fitted to and coupled with some of the plurality of coupling holes 110 of the rear chassis 100. The bracket 200 may include a plurality of hooks (e.g., first hooks 213 and second hooks 223) that are hook-coupled to coupling holes, excluding the coupling holes to which the plurality of coupling ribs (e.g., the first coupling ribs 211 and the second coupling ribs 221) are coupled, among the plurality of coupling holes 110 of the rear chassis 100.

The bracket 200 may partially penetrate the plurality of through-holes 120 of the rear chassis 100. First circuit boards 50 and 60 and a second circuit board 70 may be seated on the bracket 200 that penetrates through the plurality of through-holes 120 into the rear surface of the rear chassis 100.

The bracket 200 may include a first bracket 210 on which the first circuit board 50 is seated. The first circuit board 50 may be a power board. The power board may supply power to the second circuit board 70 on which the display panel 10 (see FIG. 1) and the plurality of light sources 20 are fixed. The bracket 200 may include a second bracket 220 on which the first circuit board 60 is seated. The first circuit board 60 may be a control board. The control board may drive and control operations of the display panel 10 (see FIG. 1) and the second circuit board 70 on which the plurality of light sources 20 are fixed.

The first bracket 210 may be coupled to the front surface of the rear chassis 100. The first bracket 210 may be coupled to the plurality of coupling holes 110 of the rear chassis 100. The first bracket 210 may include a first coupling rib 211 that is fitted to and coupled with a first coupling hole 111 of the plurality of coupling holes 110 of the rear chassis 100. The first coupling rib 211 may be formed on an upper edge of the first bracket 210. The first coupling ribs 211 may be coupled to the plurality of first coupling holes 111.

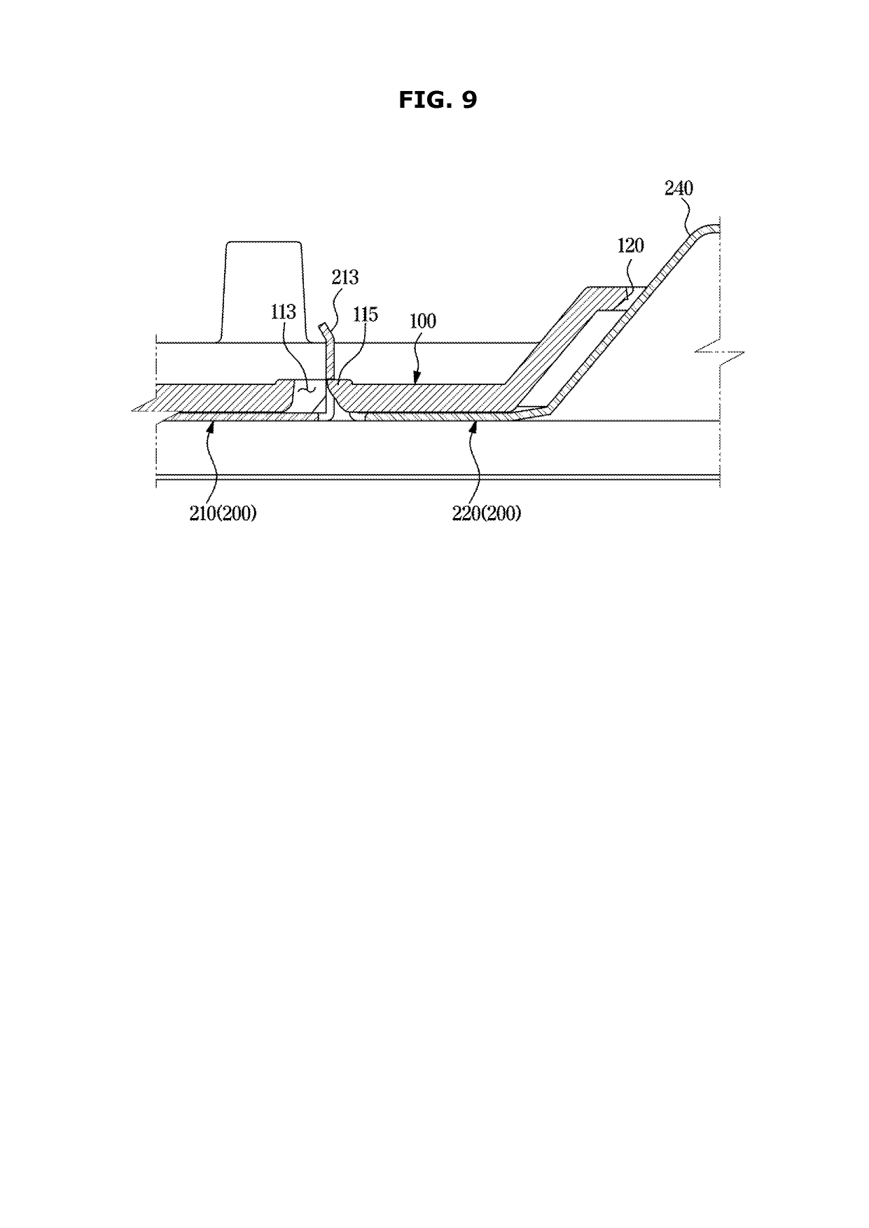

The first bracket 210 may include a first hook 213 that is hook-coupled to a third coupling hole 113 of the plurality of coupling holes 110 of the rear chassis 100. The first hook 213 may be formed on an edge other than the upper edge of the first bracket 210 on which the plurality of first coupling ribs 211 are formed. A protrusion 115 (see FIG. 9) may be formed at (e.g., in) each of a plurality of third coupling holes 113 of the rear chassis 100 to which a respective first hook 213 is hook-coupled. The first hook 213 may be coupled to the protrusion 115. The first hook 213 may be formed in plural to be coupled to the plurality of third coupling holes 113.

The first bracket 210 may be coupled to the rear chassis 100 without requiring a separate coupling member, such as a screw, because the plurality of first coupling ribs 211 and the plurality of first hooks 213 are coupled to the plurality of first coupling holes 111 and the plurality of third coupling holes 113 of the rear chassis 100, respectively. By eliminating the need for a separate coupling member, such as a screw, a coupling process may be simplified, thereby improving productivity. In addition, by not requiring a separate coupling member, such as a screw, a structure may be simplified.

The second bracket 220 may be coupled to the front surface of the rear chassis 100. The second bracket 220 may be coupled to the plurality of coupling holes 110 of the rear chassis 100. The second bracket 220 may include a second coupling rib 221 that is fitted to and coupled with a second coupling hole 112 of the plurality of coupling holes 110 of the rear chassis 100. The second coupling rib 221 may be formed on an upper edge of the second bracket 220. The second coupling ribs 221 may be provided in plural to be coupled to a plurality of second coupling holes 112.

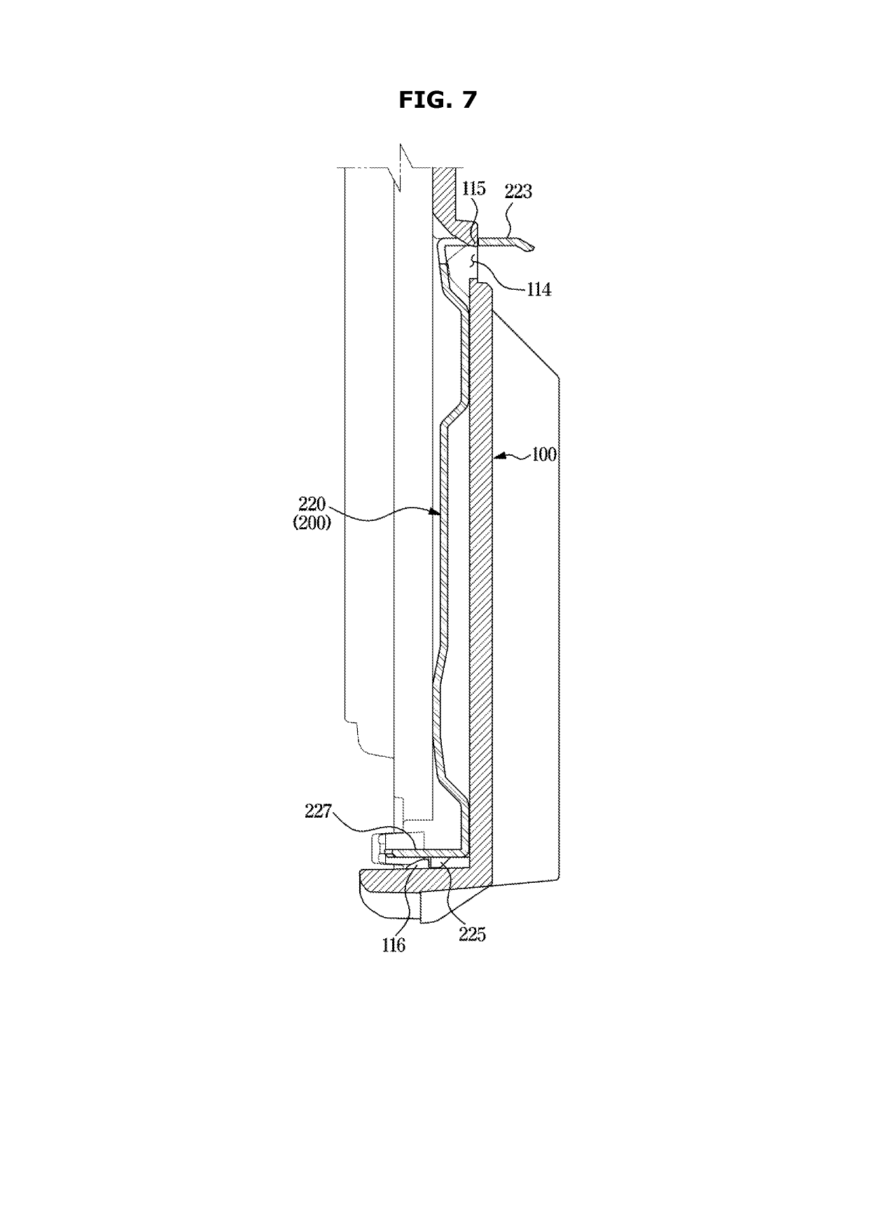

The second bracket 220 may include a second hook 223 that is hook-coupled to a fourth coupling hole 114 of the plurality of coupling holes 110 of the rear chassis 100. The second hook 223 may be formed on an edge other than the upper edge of the second bracket 220 on which the plurality of second coupling ribs 221 are formed. The protrusion 115 (see FIG. 7) may be formed at (e.g., in) each fourth coupling hole 114 of the rear chassis 100 to which a respective second hook 223 is hook-coupled. The second hook 223 may be coupled to the protrusion 115. The second hooks 223 may be provided in plural to be coupled to the plurality of fourth coupling holes 114.

The second bracket 220 may include a first coupling protrusion 225. The first coupling protrusion 225 may be coupled to a second coupling protrusion 116 formed on the rear chassis 100. The first coupling protrusion 225 may be formed on a lower edge of the second bracket 220. A plurality of the first coupling protrusions 225 may be provided. Since a plurality of the first coupling protrusions 225 may be provided , a plurality of the second coupling protrusions 116 to which the plurality of first coupling protrusions 225 is coupled may also be provided (see FIG. 7).

The second bracket 220 may be coupled to the rear chassis 100 without requiring a separate coupling member, such as a screw, because the plurality of second coupling ribs 221, the plurality of second hooks 223, and the plurality of first coupling protrusions 225 are coupled to the plurality of second coupling holes 112, the plurality of fourth coupling holes 114, and the plurality of second coupling protrusions 116 of the rear chassis 100, respectively. By eliminating the need for a separate coupling member, such as a screw, a coupling process may be simplified, thereby improving productivity. In addition, by not requiring a separate coupling member, such as a screw, a structure may be simplified.

The second bracket 220 may include a circuit board seating portion 227 on which the second circuit board 70, to which the plurality of light sources 20 is fixed, is seated. The second circuit board 70 seated on the circuit board seating portion 227 may be disposed on the rear side of the display panel 10 (see FIG. 1).

The rear chassis 100 may include the plurality of coupling holes 110 to which the bracket 200 is coupled. The bracket 200 may be coupled to the plurality of coupling holes 110. The plurality of coupling holes 110 may include the plurality of first coupling holes 111. The plurality of first coupling ribs 211 of the first bracket 210 may be fitted to and coupled with the plurality of first coupling holes 111. The plurality of first coupling holes 111 may be provided with a corresponding number of first coupling ribs 211.

The plurality of coupling holes 110 may include the plurality of second coupling holes 112. The plurality of second coupling ribs 221 of the second bracket 220 may be fitted to and coupled with the plurality of second coupling holes 112. The plurality of second coupling holes 112 may be provided with a corresponding number of second coupling ribs 221.

The plurality of coupling holes 110 may include the plurality of third coupling holes 113. The plurality of first hooks 213 of the first bracket 210 may be hook-coupled to the plurality of third coupling holes 113. Each of the plurality of third coupling holes 113 may include a respective one of the protrusions 115 to which a respective one the plurality of first hooks 213 is fixed. The plurality of first hooks 213 may be fixed to the protrusions 115, so that the plurality of first hooks 213 may be hook-coupled to the plurality of third coupling holes 113.

The plurality of coupling holes 110 may include the plurality of fourth coupling holes 114. The plurality of second hooks 223 of the second bracket 220 may be hook-coupled to the plurality of fourth coupling holes 114. Each of the plurality of fourth coupling holes 114 may include a respective one of the protrusions 115 to which a respective one of the plurality of second hooks 223 is fixed. The plurality of second hooks 223 may be fixed to the protrusions 115, so that the plurality of second hooks 223 may be hook-coupled to the plurality of fourth coupling holes 114.

The rear chassis 100 may include the plurality of second coupling protrusions 116 to which the second bracket 220 of the bracket 200 is coupled. The plurality of second coupling protrusions 116 may be formed on a lower edge of the rear chassis 100. The plurality of first coupling protrusions 225 formed on the lower edge of the second bracket 220 may be coupled to the plurality of second coupling protrusions 116 (see FIG. 7).

The bracket 200 may include a plurality of beads (e.g., first beads 230 and second beads 240) protruding in a direction toward the rear chassis 100. The plurality of beads may include a plurality of first beads 230 formed in the first bracket 210. The plurality of beads may include a plurality of second beads 240 formed in the second bracket 220.

The plurality of beads (e.g., the first beads 230 and the second beads 240) formed on the bracket 200 may penetrate the plurality of through-holes 120 of the rear chassis 100 and protrude to the rear surface of the rear chassis 100. In other words, the plurality of first beads 230 of the first bracket 210 and the plurality of second beads 240 of the second bracket 220 may penetrate the plurality of through-holes 120 of the rear chassis 100 to protrude to the rear surface of the rear chassis 100.

The first circuit boards 50 and 60 may be seated on the plurality of first beads 230 protruding towards a rear side (e.g., the rear surface) of the rear chassis 100. The first circuit board 50 (e.g., the power board) and/or the first circuit board 60 (e.g., the control board) may be seated on the plurality of first beads 230 protruding towards the rear side (e.g., the rear surface) of the rear chassis 100.

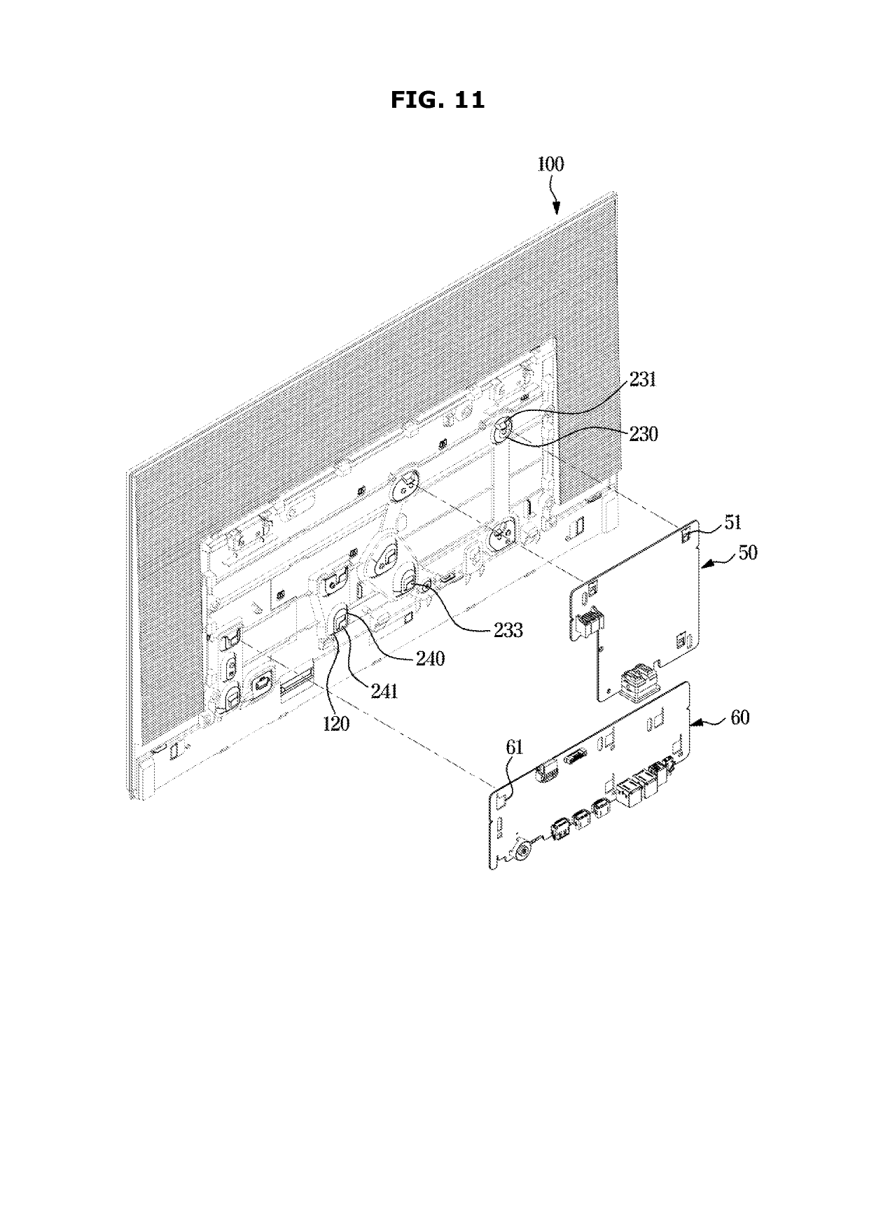

The first bracket 210 may include at least one first seating hole 231 formed in a portion of the plurality of first beads 230 and on which the first circuit board 50 (e.g., the power board) is slidably seated. The first bracket 210 may include the first seating hole 231 formed in a portion of the plurality of first beads 230 and on which the first circuit board 50 (e.g., the power board) is slidably seated. The at least one first seating hole 231 may be formed in each of a portion of the plurality of first beads 230 (see FIG. 11).

The first bracket 210 may include at least one first seating rib 233 formed on a portion of the remaining beads of the plurality of first beads 230 and on which the first circuit board 60 (e.g., the control board) is slidably seated. The first bracket 210 may include the first seating rib 233 formed on a portion of the remaining beads of the plurality of first beads 230 and on which the first circuit board 60 (e.g., the control board) is slidably seated. The at least one first seating rib 233 may be formed on each of a portion of the remaining beads of the plurality of first beads 230 (see FIG. 11).

The first circuit boards 50 and 60 may be seated on the plurality of second beads 240 protruding towards the rear side (e.g., the rear surface) of the rear chassis 100. The first circuit board 60 (e.g., the control board) may be seated on the plurality of second beads 240 protruding towards the rear side (e.g., the rear surface) of the rear chassis 100.

The second bracket 220 may include at least one second seating rib 241 formed on each of the plurality of beads of the second bracket 220 and on which the first circuit board 60 (e.g., the control board) is slidably seated.

The first circuit board 50 (e.g., the power board) of the first circuit boards 50 and 60 may include at least one seating hook 51 that is slidably seated in the at least one first seating hole 231 formed in each of a portion of the plurality of first beads 230 of the first bracket 210. The seating hook 51 may be provided in plural to correspond to a number of the first seating holes 231 (see FIG. 11).

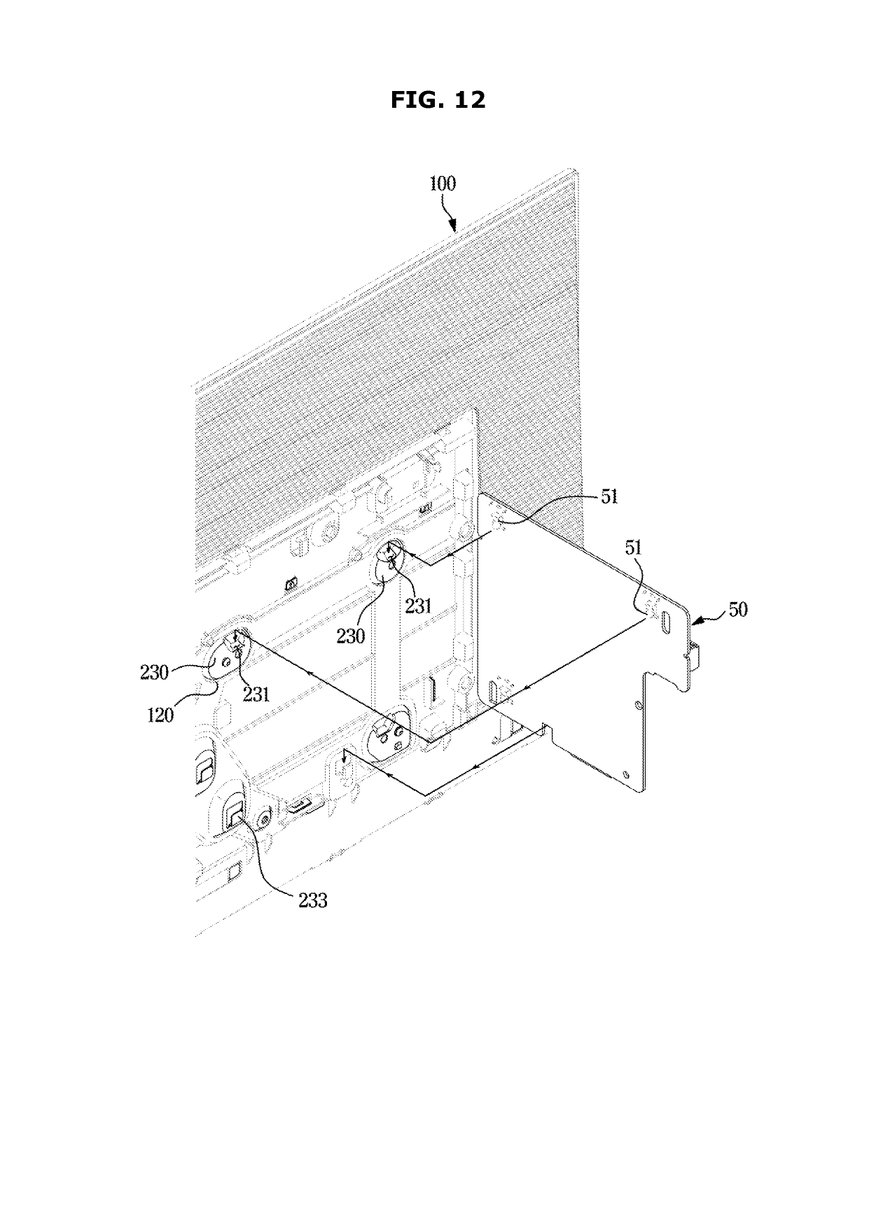

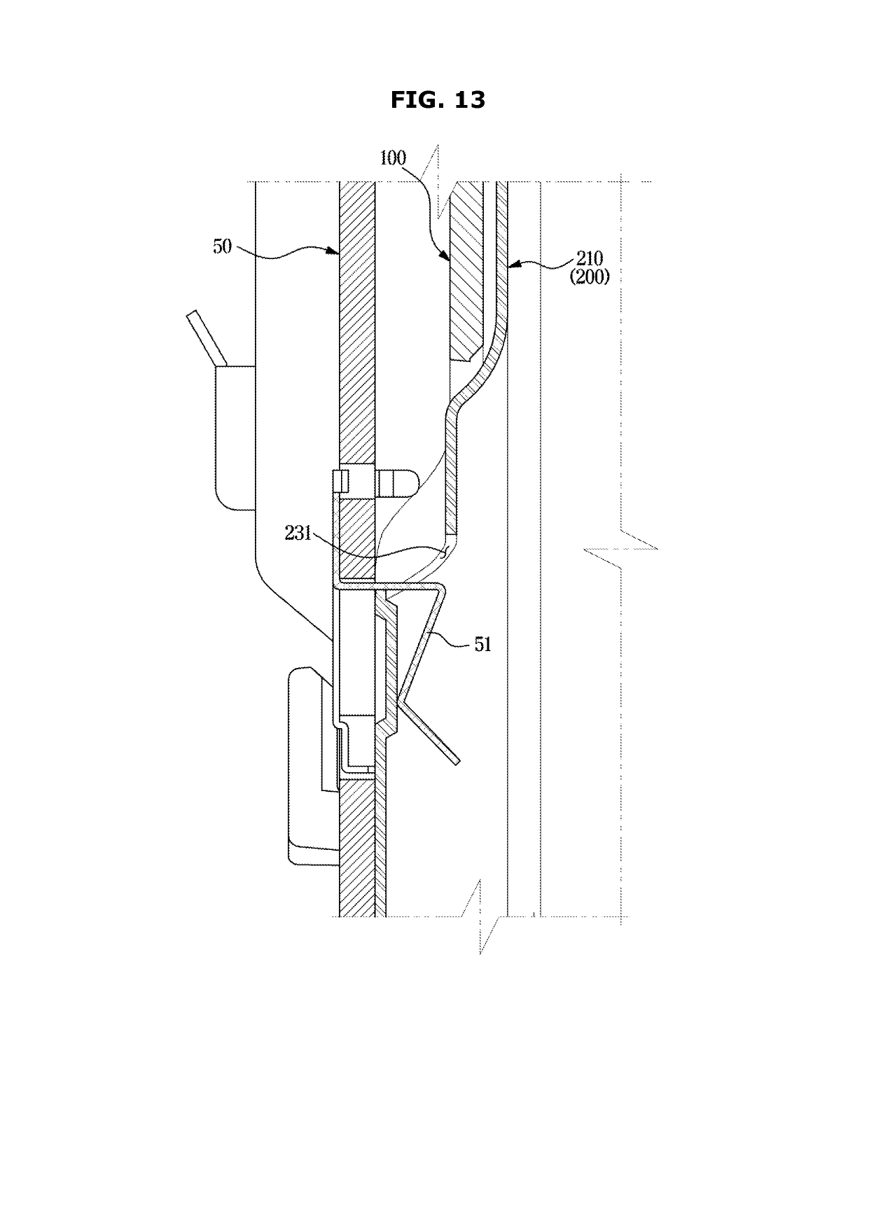

The first circuit board 60 (e.g., the control board) may include at least one second seating hole 61 that is slidably seated on the first seating rib 233 formed on each of a portion of the remaining beads of the plurality of first beads 230 of the first bracket 210. The first circuit board 60 (e.g., the control board) may include the at least one second seating hole 61 that is slidably seated on the second seating rib 241 of each of the plurality of beads of the second bracket 220. In other words, the first circuit board 60 (e.g., the control board) may include at least one second seating hole 61 that is slidably seated on the first seating rib 233 of the first bracket 210 and the second seating rib 241 of the second bracket 220 (see FIGS. 12 and 13).

As described above, the first circuit boards 50 and 60 may be seated on the bracket 200 coupled to the rear chassis 100 without the need for a separate member, such as a screw. By eliminating the need for a separate member, such as a screw, a process of seating the first circuit boards 50 and 60 on the bracket 200 may be simplified, thereby improving productivity. In addition, by not requiring a separate member, such as a screw, a structure may be simplified.

In addition, as described above, since the bracket 200 is coupled to the front surface of the rear chassis 100 and the first circuit boards 50 and 60 are seated on the bracket 200 at the rear surface of the rear chassis 100, the rear chassis 100 may be positioned between the bracket 200 and the first circuit boards 50 and 60. Since the chassis 100, which may be injected molded, is positioned between the bracket 200 and the first circuit boards 50 and 60, a separate sheet for insulating the first circuit boards 50 and 60 may not be required. In other words, in the case where the rear chassis 100 is made of metal, a separate sheet for insulating the first circuit boards 50 and 60 may be required between the rear chassis 100 and the first circuit boards 50 and 60. However, since the rear chassis 100 may be injection molded, a separate sheet for insulating the first circuit boards 50 and 60 may not be required. For example, the rear chassis 100 may be formed of an insulating material (e.g., polymers (e.g., plastic) that are used in an injection molding process to from the rear chassis 100.

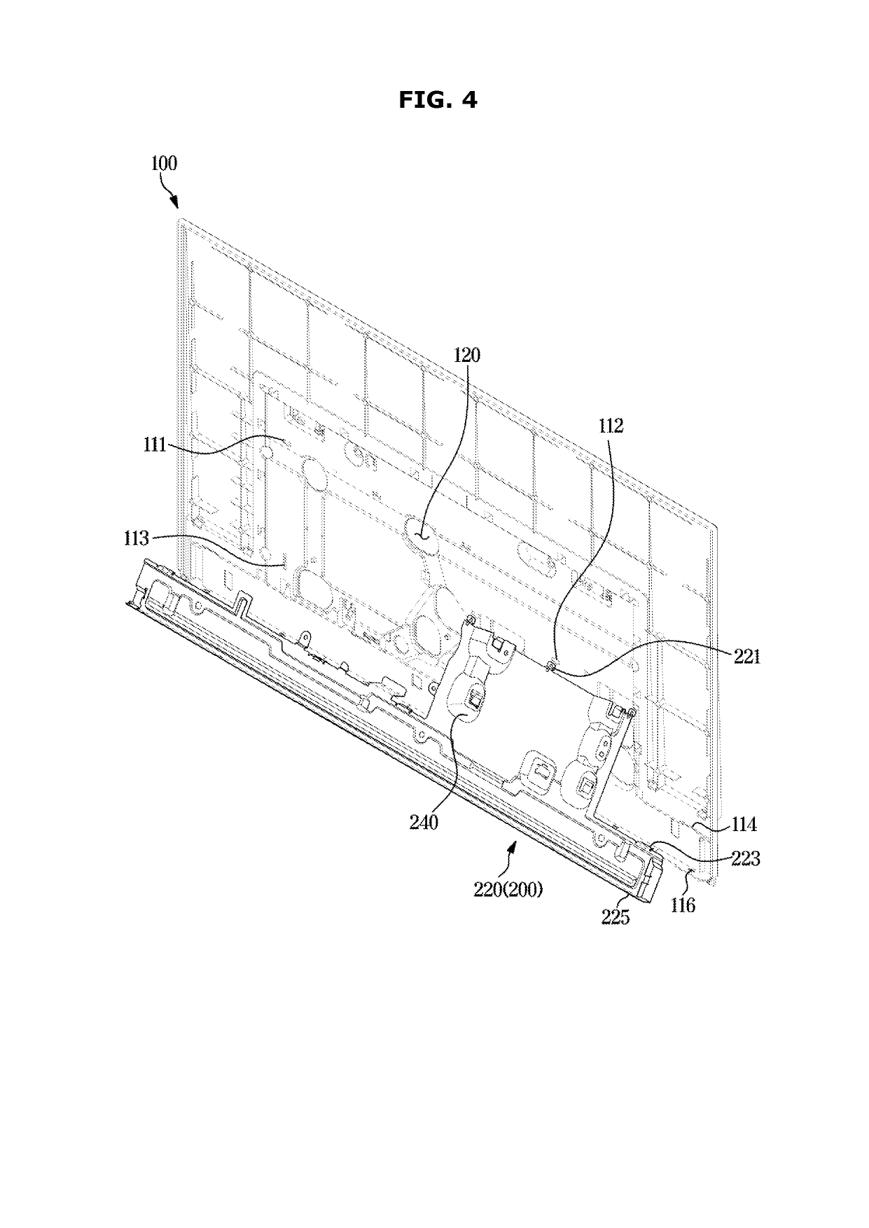

Next, with reference to FIGS. 4 to 14, a process by which the bracket 200 is coupled to the front surface of the rear chassis 100 and a process by which the first circuit boards 50 and 60 are seated on the bracket 200 at the rear surface of the rear chassis 100 will be discussed in detail.

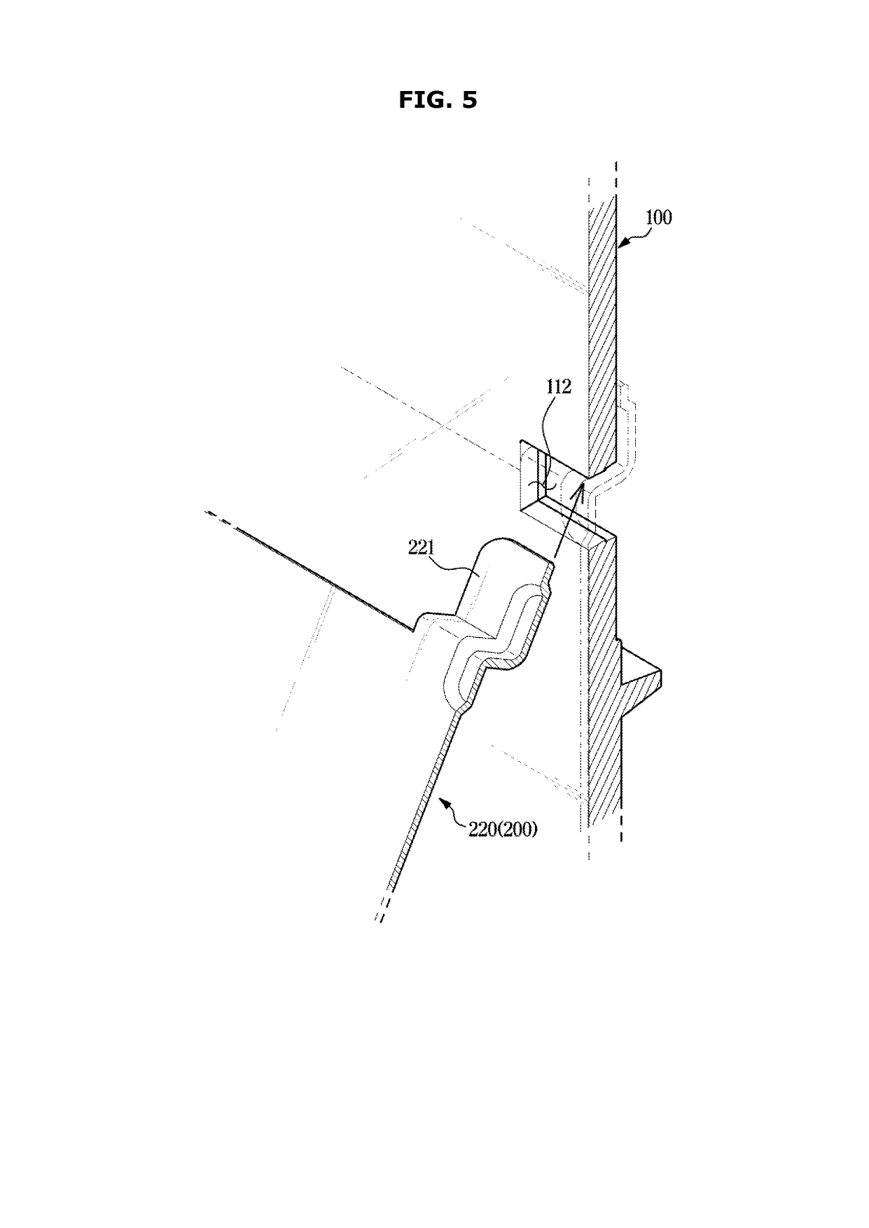

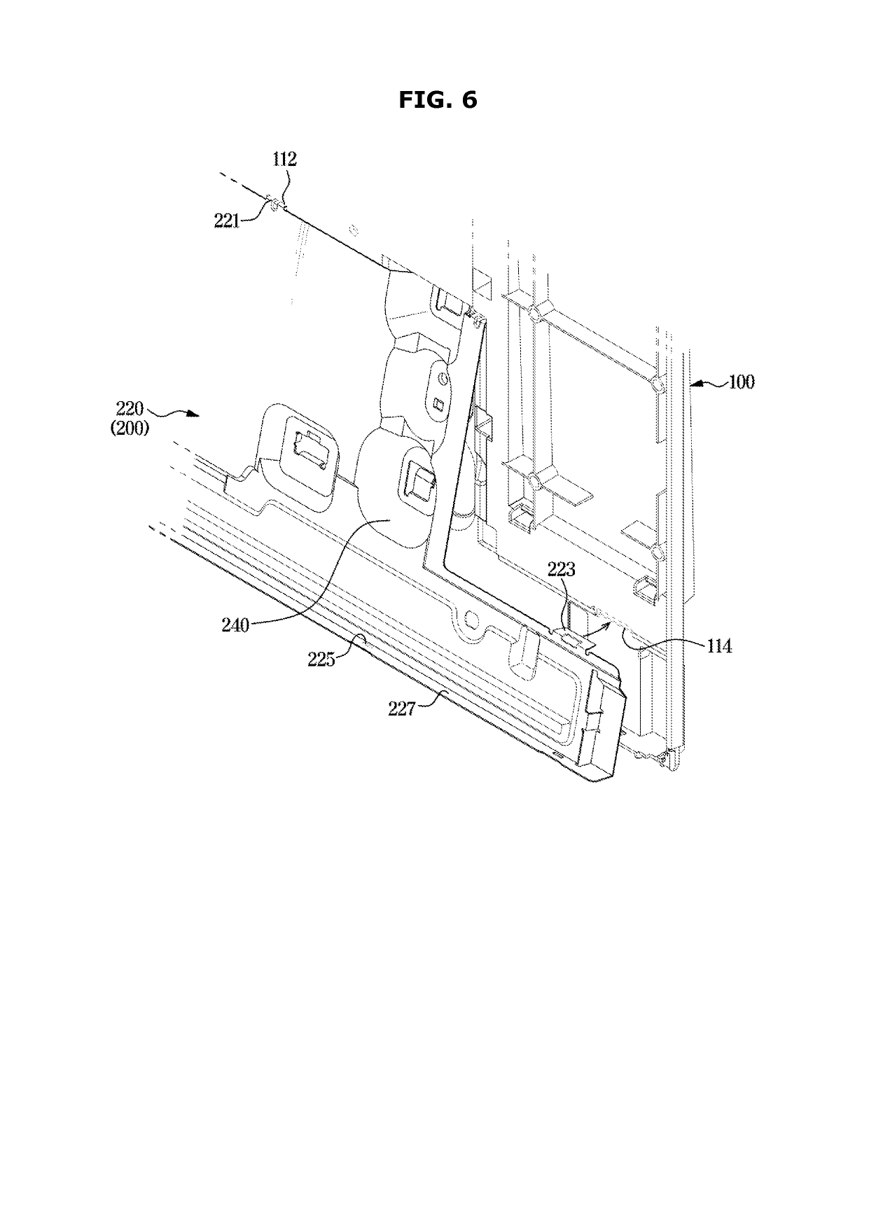

FIG. 4 is a view illustrating a state in which a plurality of second coupling ribs of a second bracket is coupled to a plurality of second coupling holes of the rear chassis according to an embodiment. FIG. 5 is an enlarged view illustrating a state in which the second coupling rib is coupled to the second coupling hole according to an embodiment. FIG. 6 is a view illustrating a state in which a plurality of second hooks of a second bracket is hook-coupled to a plurality of fourth coupling holes of the rear chassis according to an embodiment. FIG. 7 is a cross-sectional view illustrating a state in which the second hook is hook-coupled to the fourth coupling hole according to an embodiment.

As shown in FIGS. 4 and 5, the second bracket 220 may be coupled to the rear chassis 100 at the front surface of the rear chassis 100. The second bracket 220 may be coupled to the rear chassis 100 by fitting the plurality of second coupling ribs 221 formed on the upper edge of the second bracket 220 into the plurality of second coupling holes 112 of the rear chassis 100.

When the plurality of second coupling ribs 221 is coupled to the plurality of second coupling holes 112, the plurality of second hooks 223 of the second bracket 220 may be pushed in to be hook-coupled to the plurality of fourth coupling holes 114 of the rear chassis 100, as shown in FIG. 6.

As shown in FIG. 7, since the protrusion 115 may be formed at (e.g., in) each of the plurality of fourth coupling holes 114, each of the plurality of second hooks 223 may be fixed to a respective protrusion 115 when the plurality of second hooks 223 is pushed into the plurality of fourth coupling holes 114. With each of the plurality of second hooks 223 fixed to a respective protrusion 115, the plurality of second hooks 223 may be hook-coupled to the plurality of fourth coupling holes 114.

When the plurality of second hooks 223 is hook-coupled to the plurality of fourth coupling holes 114, the plurality of first coupling protrusions 225 of the second bracket 220 may be coupled to the plurality of second coupling protrusions 116 of the rear chassis 100 (see FIGS. 2 and 6).

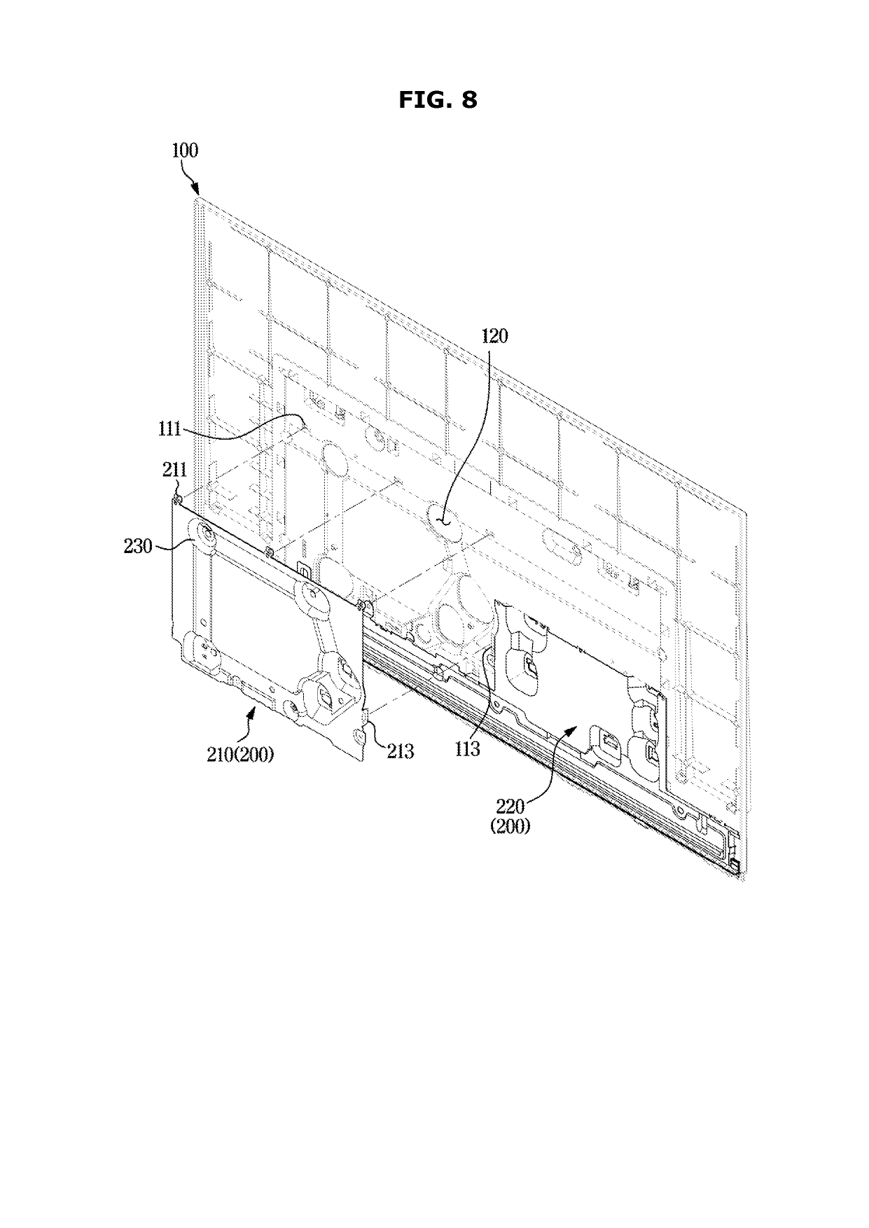

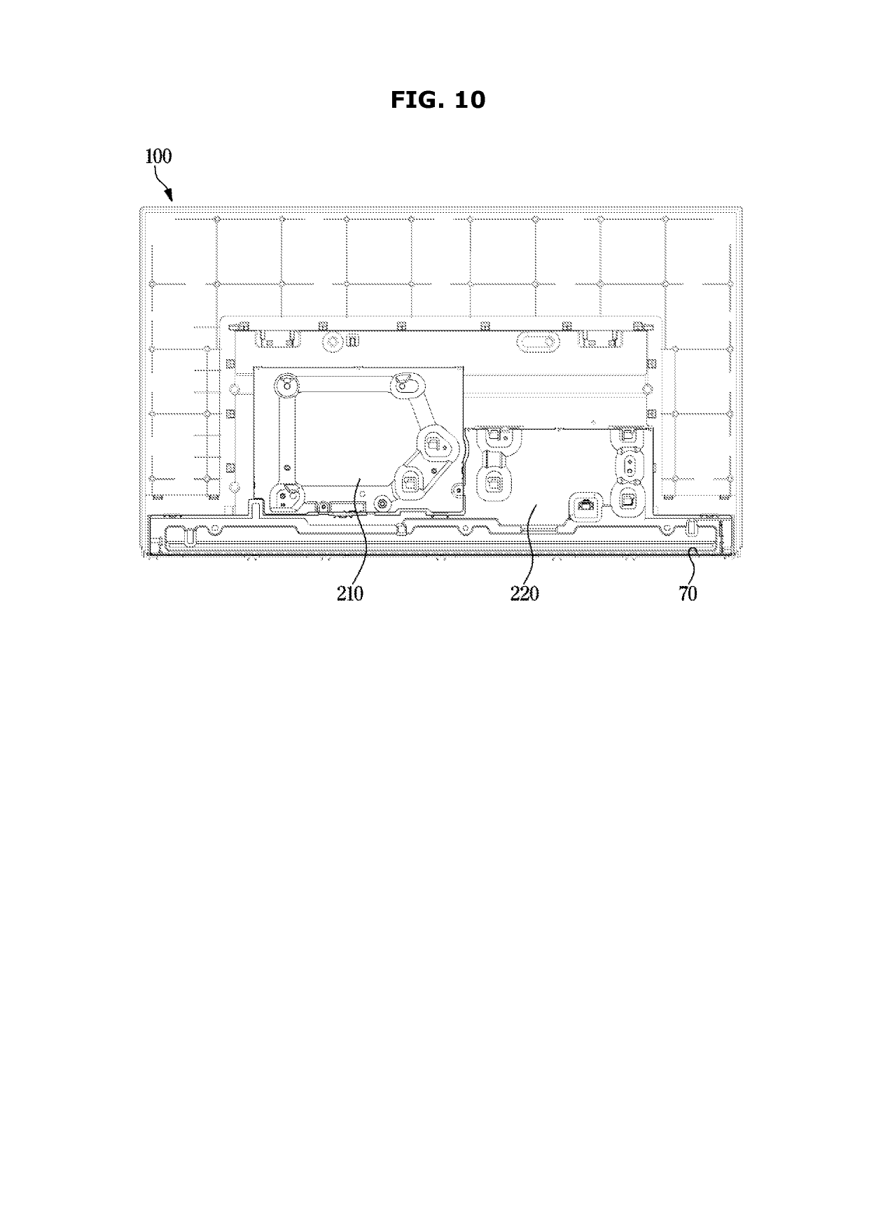

FIG. 8 is a view illustrating a state in which a plurality of first coupling ribs of a first bracket is coupled to a plurality of first coupling holes of a rear chassis according to an embodiment. FIG. 9 is a cross-sectional view illustrating a state in which a first hook is hook-coupled to a third coupling hole according to an embodiment. FIG. 10 is a view illustrating a state in which a first bracket and a second bracket are coupled to a front surface of a rear chassis according to an embodiment.

As shown in FIG. 8, the first bracket 210 may be coupled to the rear chassis 100 at the front surface of the rear chassis 100 after the second bracket 220 is coupled to the front surface of the rear chassis 100. The first bracket 210 may be coupled to the rear chassis 100 by fitting the plurality of first coupling ribs 211 formed on the upper edge of the first bracket 210 into the plurality of first coupling holes 111 of the rear chassis 100. The state in which the plurality of first coupling ribs 211 is coupled to the plurality of first coupling holes 111 may be the same as the state in which the second coupling rib 221 shown in FIG. 5 is coupled to the second coupling hole 112.

When the plurality of first coupling ribs 211 is coupled to the plurality of first coupling holes 111, the first hook 213 of the first bracket 210 may be hook-coupled to the third coupling hole 113 of the rear chassis 100, as shown in FIG. 9.

When the plurality of first hooks 213 of the first bracket 210 is hook-coupled to the plurality of third coupling holes 113 of the rear chassis 100, the first bracket 210 and the second bracket 220 may be coupled to the front surface of the rear chassis 100, as shown in FIG. 10.

FIG. 11 is a view illustrating a state in which a power board and a control board are seated on a bracket from a rear surface of the rear chassis according to an embodiment. FIG. 12 is a view illustrating a state in which a power board is being seated on a first bracket according to an embodiment. FIG. 13 is a cross-sectional view illustrating a state in which a power board is seated on a first bracket according to an embodiment.

As shown in FIGS. 11 to 13, the first circuit board 50 (e.g., the power board) may be seated in the first seating hole 231 formed in each of a portion of the plurality of first beads 230 of the first bracket 210 protruding towards the rear side (e.g., the rear surface) of the rear chassis 100 at the rear surface of the rear chassis 100. The first circuit board 50 (e.g., the power board) may be seated by the plurality of seating hooks 51 formed on the first circuit board 50 (e.g., the power board) sliding into the plurality of first seating holes 231 of the first bracket 210. With reference to the drawings, when the plurality of seating hooks 51 formed on the first circuit board 50 (e.g., the power board) is positioned above the plurality of first seating holes 231 of the first bracket 210, and then the first circuit board 50 (e.g., the power board) is moved downward, the plurality of seating hooks 51 may be inserted into and seated in the plurality of first seating holes 231.

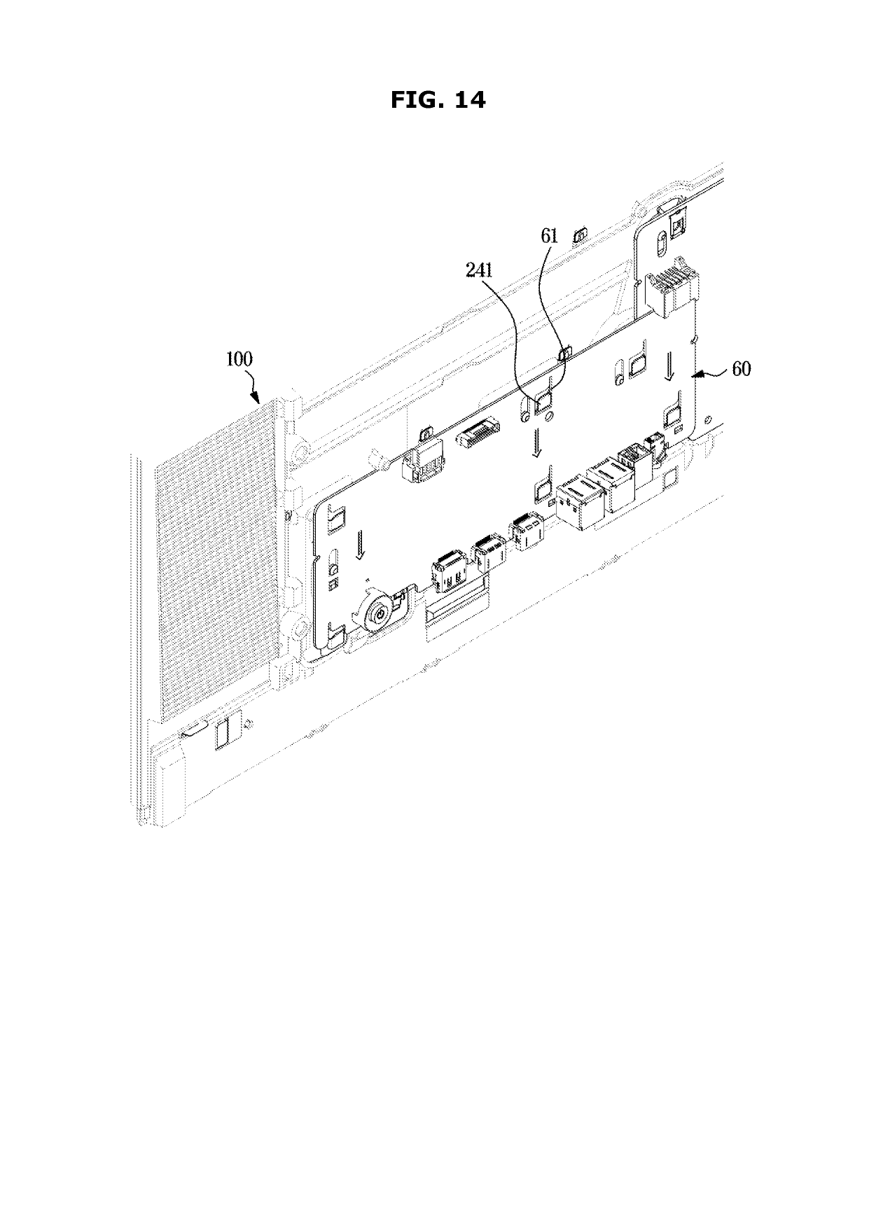

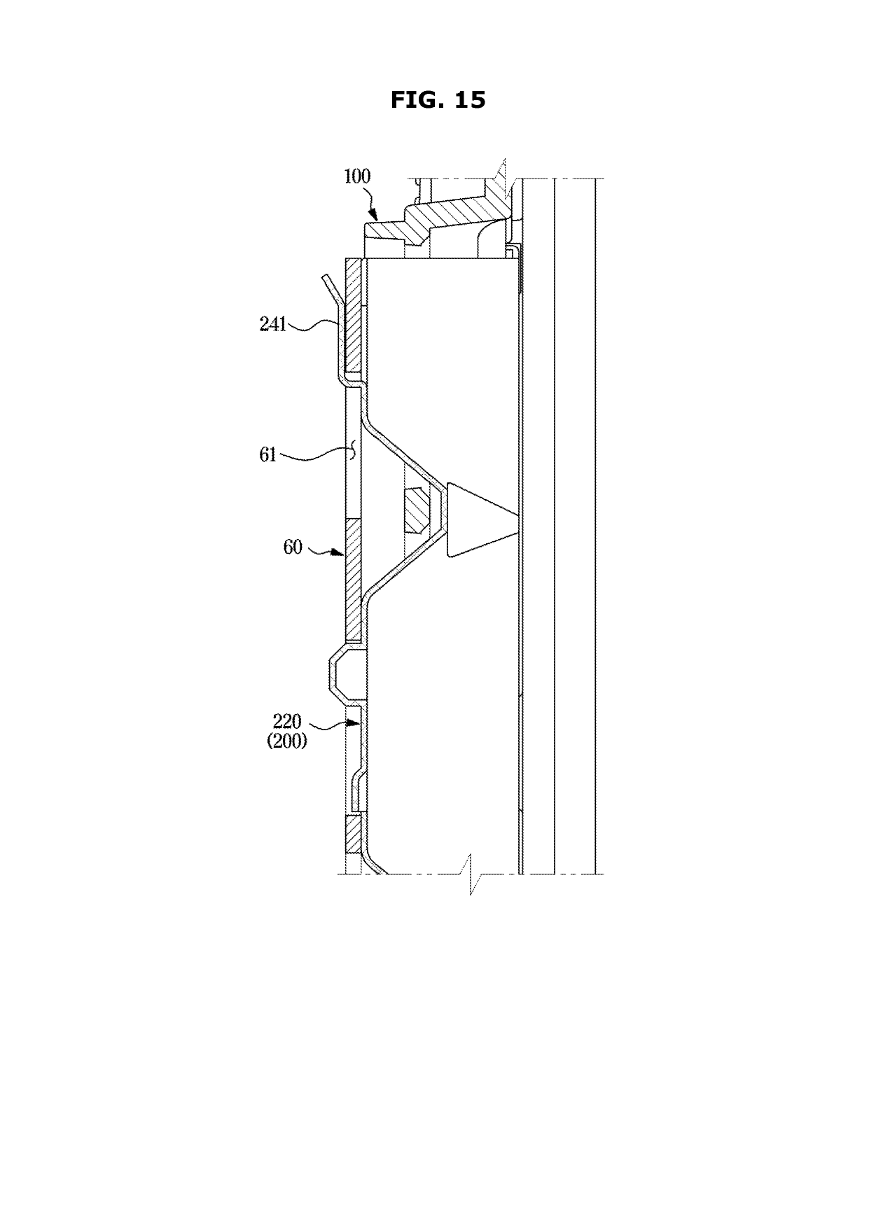

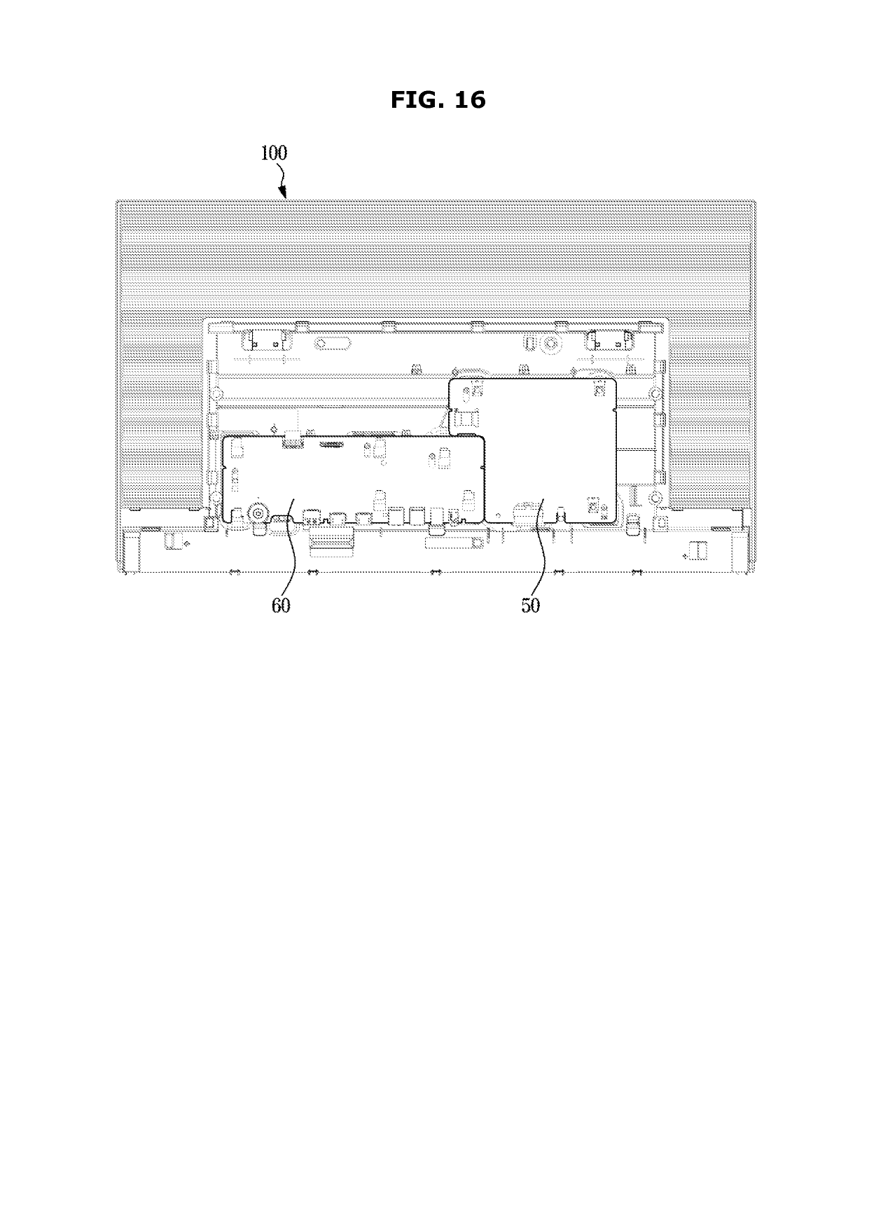

FIG. 14 is a view illustrating a state in which a control board is seated on a first bracket and a second bracket according to an embodiment. FIG. 15 is a cross-sectional view illustrating a state in which a control board is seated on a first bracket and a second bracket according to an embodiment. FIG. 16 is a view illustrating a state in which a power board and a control board are seated on a first bracket and a second bracket from a rear surface of the rear chassis according to an embodiment.

As shown in FIGS. 14 to 16, the first circuit board 60 (e.g., the control board) may be seated on the plurality of first seating ribs 233 of each of the remaining beads, excluding the beads on which the first seating holes 231 are formed, of the plurality of first beads 230 of the first bracket 210 protruding towards the rear side (e.g., the rear surface) of the rear chassis 100 from the rear surface of the rear chassis 100. The first circuit board 60 (e.g., the control board) may be seated on the plurality of second seating ribs 241 of each of the plurality of second beads 240 of the second bracket 220 protruding towards the rear side (e.g., the rear surface) of the rear chassis 100 from the rear surface of the rear chassis 100. In other words, the first circuit board 60 (e.g., the control board) may be seated by the plurality of first seating ribs 233 (see FIG. 11) of the first bracket 210 and the plurality of second seating ribs 241 (see FIG. 11) of the second bracket 220 sliding into the plurality of second seating holes 61 of the first circuit board 60 (e.g., the control board).

Based on the drawings, when the plurality of second seating holes 61 of the first circuit board 60 (e.g., the control board) is positioned above the plurality of first seating ribs 233 of the first bracket 210 and the plurality of second seating ribs 241 of the second bracket 220, and then the first circuit board 60 (e.g., the control board) is moved downward, the plurality of first seating ribs 233 and the plurality of second seating ribs 241 may be inserted into and seated in the plurality of second seating holes 61.

The display apparatus according to an embodiment of the disclosure may include the display panel 10, the rear chassis 100 formed by injection molded and disposed on a rear side of the display panel, the rear chassis including the plurality of coupling holes 110, the bracket 200 coupled to the plurality of coupling holes on a front surface of the rear chassis, the first circuit boards 50 and 60 seated on the bracket from a rear surface of the rear chassis, and the second circuit board 70 on which the plurality of light sources 20 is fixed at the front surface of the rear chassis. The bracket may include the plurality of coupling ribs (e.g., the first coupling ribs 211 and the second coupling ribs 221) fitted and coupled to a portion of the plurality of coupling holes, and the plurality of hooks (e.g., the first hooks 213 and the second hooks 223) hook-coupled to the remaining coupling holes of the plurality of coupling holes.

The bracket may include the first bracket 210 on which the first circuit board is seated, and the second bracket 220 on which the first circuit board and the second circuit board are seated.

The plurality of coupling ribs may include the plurality of first coupling ribs (e.g., the first coupling ribs 211 and the second coupling ribs 221) formed on an upper edge of the first bracket, and the plurality of second coupling ribs 221 formed on an upper edge of the second bracket.

The plurality of coupling holes may include the plurality of first coupling holes 111 to which the plurality of first coupling ribs is fitted and coupled, and the plurality of second coupling holes 112 to which the plurality of second coupling ribs is fitted and coupled.

The plurality of hooks may include the plurality of first hooks 213 formed on an edge excluding an upper edge of the first bracket, and the plurality of second hooks 223 of the second bracket.

The plurality of coupling holes may include the plurality of third coupling holes 113 to which the plurality of first hooks is hook-coupled, and the plurality of fourth coupling holes 114 to which the plurality of second hooks is hook-coupled.

Each of the plurality of third coupling holes and the plurality of fourth coupling holes may include the protrusion 115 to which the first hook and the second hook are fixed.

The first circuit board may be coupled to the rear chassis such that the rear chassis is positioned between the first circuit board and the bracket.

The second bracket may include the plurality of first coupling protrusions 225 coupled to the rear chassis.

The rear chassis may include the plurality of second coupling protrusions 116 to which the plurality of first coupling protrusions is coupled.

The first bracket and the second bracket may include the plurality of beads (e.g., the first beads 230 and the second beads 240) protruding in a direction toward the rear chassis.

The rear chassis may include the plurality of through-holes 120 in which the plurality of beads penetrates to allow the plurality of beads to protrude to the rear surface of the rear chassis.

The first circuit board may include the first circuit board 50 (e.g., the power board) seated on the first bracket and the first circuit board 60 (e.g., the control board) seated on the first bracket and the second bracket. The first bracket may include the first seating hole 231 formed on a portion of a plurality of beads of the first bracket among the plurality of beads and on which the power board is slidably seated, and the first seating rib 233 formed on the remaining of the plurality of beads of the first bracket among the plurality of beads and on which the control board is slidably seated. The second bracket may include the second seating rib 241 formed on each of the plurality of beads of the second bracket and on which the control board is slidably seated.

The power board may include the seating hook 51 configured to by slidably seated in the first seating hole, and the control board may include at least one second seating hole 61 in which the first seating rib and the second seating rib are slidably seated.

The second bracket may include the circuit board seating portion 227 on which the second circuit board is seated.

The display apparatus according to an embodiment of the disclosure may include the display panel 10, the rear chassis which is injection molded and disposed on a rear side of the display panel and includes the plurality of coupling holes 110 and the plurality of through-holes 120, the bracket 200 coupled to the plurality of coupling holes from a front surface of the rear chassis and including the plurality of beads (e.g., the first beads 230 and the second beads 240) protruding to a rear surface of the rear chassis through the plurality of through-holes, and the first circuit boards 50 and 60 seated on the plurality of beads from the rear surface of the rear chassis, the first circuit board on which the rear chassis is positioned between the bracket and the first circuit board.

The bracket may include the first bracket 210 on which the first circuit board is seated, and the second bracket 220 on which the first circuit board and the second circuit board 70 on which the plurality of light sources 20 are fixed, are seated.

The first bracket may include the plurality of first coupling ribs (e.g., the first coupling ribs 211 and the second coupling ribs 221) formed on an upper edge of the first bracket and coupled to the plurality of coupling holes, and the plurality of first hooks 213 formed on a remaining edge excluding the upper edge of the first bracket and coupled to the plurality of coupling holes.

The second bracket may include the plurality of second coupling ribs 221 formed on an upper edge of the second bracket and coupled to the plurality of coupling holes, the plurality of second hooks 223 of the second bracket and coupled to the plurality of coupling holes, and the plurality of first coupling protrusions 225 coupled to the rear chassis.

The rear chassis may include the plurality of second coupling protrusions 116 to which the plurality of first coupling protrusions is coupled.

According to various embodiments of the disclosure, the display apparatus may be lightweight by injection molding the rear chassis.

In addition, by improving the coupling structure of the bracket, a separate coupling member for coupling the bracket to the rear chassis may be eliminated.

In addition, by improving the coupling structure of the bracket, a structure for coupling the bracket to the rear chassis may be simplified.

In addition, productivity may be improved by injection molding the rear chassis and improving the coupling structure of the bracket coupled to the rear chassis.

Effects obtained by embodiments of the disclosure are not limited to the effects mentioned above, and other unmentioned effects of embodiments of the disclosure can be clearly understood by those of ordinary skill in the art to which the disclosure pertains.

While non-limiting example embodiments of the disclosure have been particularly described with reference to the accompanying drawings, it should be understood by those of skilled in the art that various changes in form and details may be made without departing from the spirit and scope of the disclosure.

What is claimed is:

1. A display apparatus comprising:
a display panel;
a rear chassis on a rear side of the display panel, the rear chassis including a plurality of coupling holes;
at least one bracket on a front side of the rear chassis, the at least one bracket coupled to the plurality of coupling holes;
at least one first circuit board on a rear side of the rear chassis, the at least one first circuit board being on at least a portion of the at least one bracket, the portion protruding through the rear chassis;
a light source on a front surface of the rear chassis; and
a second circuit board connected to the light source;
wherein the at least one bracket comprises:
a plurality of coupling ribs coupled to first coupling holes from among the plurality of coupling holes; and
a plurality of hooks coupled to second coupling holes from among the plurality of coupling holes.

2. The display apparatus of claim 1, wherein the at least one bracket comprises:
a first bracket, wherein the at least one first circuit board is on at least a portion of the first bracket, the portion of the first bracket protruding through the rear chassis, and
a second bracket, wherein the at least one first circuit board is on at least a portion of the second bracket, the portion of the second bracket protruding through the rear chassis, and the second circuit board is on the second bracket.

3. The display apparatus of claim 2, wherein the first bracket comprises a first coupling rib, from among the plurality of couplings ribs, on an upper edge of the first bracket, and
the second bracket comprises a second coupling rib, from among the plurality of coupling ribs, on an upper edge of the second bracket.

4. The display apparatus of claim 3, wherein the first coupling rib and the second coupling rib are in respective ones of the first coupling holes.

5. The display apparatus of claim 2, wherein the plurality of hooks comprises a first hook and a second hook,
wherein the first bracket comprises the first hook on an edge of the first bracket, other than an upper edge of the first bracket, and
wherein the second bracket comprises the second hook.

6. The display apparatus of claim 5, wherein the first hook and the second hook are coupled to respective ones of the second coupling holes.

7. The display apparatus of claim 6, wherein the rear chassis further comprises:
a first protrusion to which the first hook is fixed; and
a second protrusion to which the second hook is fixed, and
wherein the first protrusion and the second protrusion are at the respective ones of the second coupling holes.

8. The display apparatus of claim 1, wherein the at least one first circuit board is coupled to the rear chassis such that the rear chassis is between the at least one first circuit board and the at least one bracket.

9. The display apparatus of claim 2, wherein the second bracket comprises a first coupling protrusion coupled to the rear chassis.

10. The display apparatus of claim 9, wherein the rear chassis comprises a second coupling protrusion that is coupled to the first coupling protrusion.

11. The display apparatus of claim 2, wherein the first bracket and the second bracket comprise at least one bead, the at least one bead protruding in a direction toward the rear chassis.

12. The display apparatus of claim 11, wherein the rear chassis comprises at least one through-hole, and
the at least one bead protrudes, in the at least one through-hole, towards the rear side of the rear chassis.

13. The display apparatus of claim 12, wherein the at least one first circuit board comprises:
a power board on the first bracket; and
a control board on the first bracket and the second bracket,
the at least one bead of the first bracket is a plurality of first beads,
the first bracket further comprises:
a first seating hole in a first bead from among the plurality of first beads, and a portion of the power board is in the first seating hole; and
a first seating rib on another first bead from among the plurality of first beads, and the control board is on the first seating rib, and
the second bracket further comprises a second seating rib on the at least one bead of the second bracket, and the control board is on the second seating rib.

14. The display apparatus of claim 13, wherein the power board comprises a seating hook that is within the first seating hole,
the control board comprises a plurality of second seating holes, and
the first seating rib and the second seating rib are within the plurality of second seating holes.

15. The display apparatus of claim 2, wherein the second bracket further comprises a circuit board seating portion, and
the second circuit board is on the circuit board seating portion.

16. A display apparatus comprising:
a display panel;
a rear chassis on a rear side of the display panel, the rear chassis including at least one coupling hole and at least one through-hole;
a bracket on a front side of the rear chassis, the bracket coupled to the at least one through-hole, and the bracket comprising at least one bead protruding, in the at least one through-hole, towards a rear side of the rear chassis, and
at least one first circuit board on the at least one bead, on a rear side of the rear chassis,
wherein the rear chassis is between the bracket and the at least one first circuit board.

17. A display apparatus comprising:
a display panel;
a rear chassis on a rear side of the display panel, the rear chassis including a plurality of coupling holes;
at least one bracket on a front side of the rear chassis, the at least one bracket coupled to the plurality of coupling holes;
at least one first circuit board on a rear side of the rear chassis, the at least one first circuit board being on at least a portion of the at least one bracket, the portion protruding through the rear chassis;
wherein the at least one bracket comprises:
a plurality of coupling ribs coupled to first coupling holes from among the plurality of coupling holes; and
a plurality of hooks coupled to second coupling holes from among the plurality of coupling holes.

18. The display apparatus of claim 1, wherein the at least one bracket comprises:
a first bracket, wherein the at least one first circuit board is on at least a portion of the first bracket, the portion of the first bracket protruding through the rear chassis, and
a second bracket, wherein the at least one first circuit board is on at least a portion of the second bracket, the portion of the second bracket protruding through the rear chassis, and the second circuit board is on the second bracket.

19. The display apparatus of claim 2, wherein the first bracket comprises a first coupling rib, from among the plurality of couplings ribs, on an upper edge of the first bracket, and
the second bracket comprises a second coupling rib, from among the plurality of couplings ribs, on an upper edge of the second bracket.

20. The display apparatus of claim 3, wherein the first coupling rib and the second coupling rib are in respective ones of the first coupling holes.
